(19) United States
(12) Patent Application Publication
(10) Pub. No.: US 2024/0389092 A1
(43) Pub. Date: Nov. 21, 2024

(54) REDUCED CANCELATION INDICATION MONITORING

(71) Applicant: QUALCOMM Incorporated, San Diego, CA (US)

(72) Inventors: Ahmed Attia ABOTABL, San Diego, CA (US); Diana MAAMARI, San Diego, CA (US)

(21) Appl. No.: 18/319,695

(22) Filed: May 18, 2023

(51) Int. Cl. H04W 72/12; H04W 72/232

(52) U.S. Cl. CPC H04W 72/12; H04W 72/232

(57) ABSTRACT

Certain aspects of the present disclosure provide method for wireless communication by a user equipment (UE), generally including receiving, from a network entity, signaling indicating a configuration of monitoring occasions for the UE to monitor for an indication that indicates cancelation of at least a portion of a scheduled physical uplink shared channel (PUSCH) or at least a portion of a scheduled physical downlink shared channel (PDSCH) and selectively monitoring a limited subset of the monitoring occasions for the indication when at least one condition is met.

### BACKGROUND

### Field of the Disclosure

Aspects of the present disclosure relate to wireless communications, and more particularly, to techniques for selectively monitoring for a cancelation indication.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes receiving, from a network entity, signaling indicating a configuration of monitoring occasions for the UE to monitor for an indication that indicates cancelation of at least a portion of a scheduled physical uplink shared channel (PUSCH) or at least a portion of a scheduled physical downlink shared channel (PDSCH); and selectively monitoring a limited subset of the monitoring occasions for the indication when at least one condition is met.

Another aspect provides a method for wireless communication by a network entity. The method includes transmitting first signaling indicating a configuration for a user equipment (UE) to monitor for an indication that indicates cancelation of at least a portion of a scheduled physical uplink shared channel (PUSCH) or at least a portion of a scheduled physical downlink shared channel (PDSCH); and transmitting second signaling configuring the UE to selectively monitor a limited subset of the monitoring occasions for the indication when at least one condition is met.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts an example timeline illustrating uplink (UL) cancellation indication (ULCI) signaling.

FIG. 6 depicts an example call flow diagram for reduced cancelation indication monitoring, in accordance with aspects of the present disclosure.

FIG. 7 depicts a table illustrating different quality of service (QoS) parameters.

FIG. 8 depicts an example of traffic patterns for an extended reality (XR) scenario.

FIG. 9 depicts a method for wireless communications.

FIG. 10 depicts a method for wireless communications.

FIG. 11 depicts aspects of an example communications device.

### DETAILED DESCRIPTION

Aspects of the present disclosure provide apparatuses, methods, processing systems, and computer-readable mediums for selectively monitoring for cancelation indication.

Uplink cancellation generally refers to a technique that allows a network to prioritize certain types of traffic over other types of traffic. For example, the network may transmit an uplink cancelation indication (ULCI) to cancel a portion of resources allocated for a previously-scheduled uplink transmission for low priority traffic by a first user equipment (UE), in order to reallocate those resources for transmission of higher priority traffic by another UE.

There are certain times when a UE may not expect ULCI. For example, if a UE is in a state where it expects only downlink transmissions, there may be no uplink transmissions to cancel. In such cases, it is a waste for the UE to monitor for ULCI and results in needless power consumption. A UE is typically configured to monitor for certain types of downlink control information (DCI) that conveys ULCI via radio resource control (RRC) configuration. Thus, to reconfigure a UE to not monitor for ULCI typically involves RRC reconfiguration, which is time consuming. Further, by the time RRC reconfiguration occurs, conditions may have changed, such that the UE might again expect ULCI.

Certain aspects of the current disclosure provide techniques that may allow a UE to selectively monitor for ULCI. For example, the UE may be configured to skip monitoring for ULCI when certain conditions are met. By configuring a UE to selectively monitor for ULCI in this manner, aspects of the present disclosure may help improve the battery life when ULCI is not expected, while still allowing ULCI functionality and the network flexibility to prioritize certain types of traffic.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

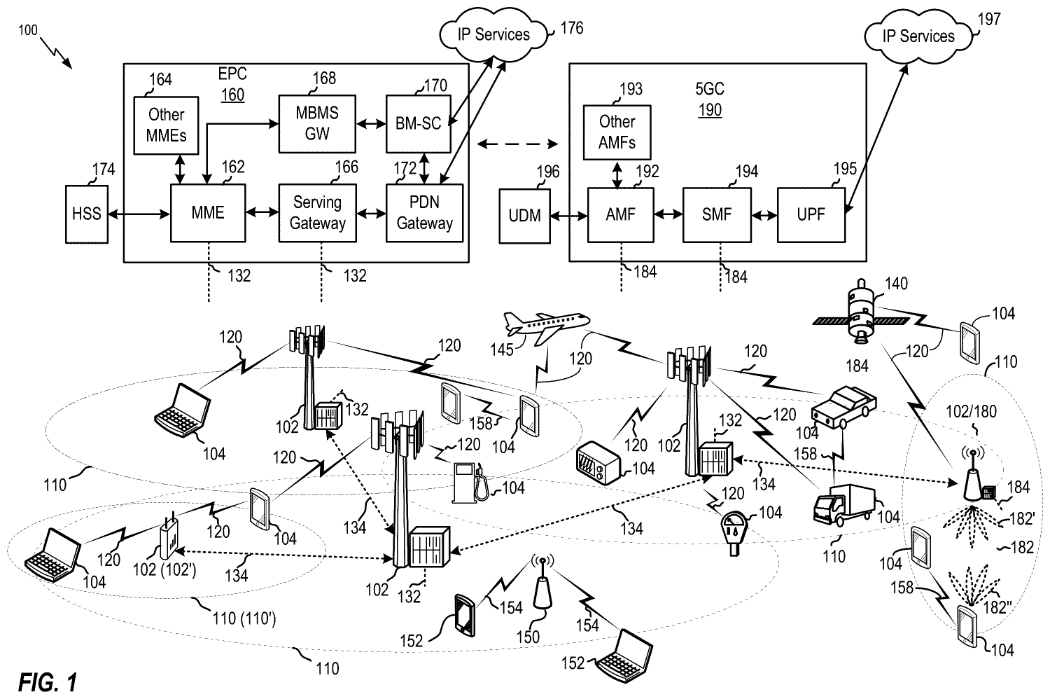

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

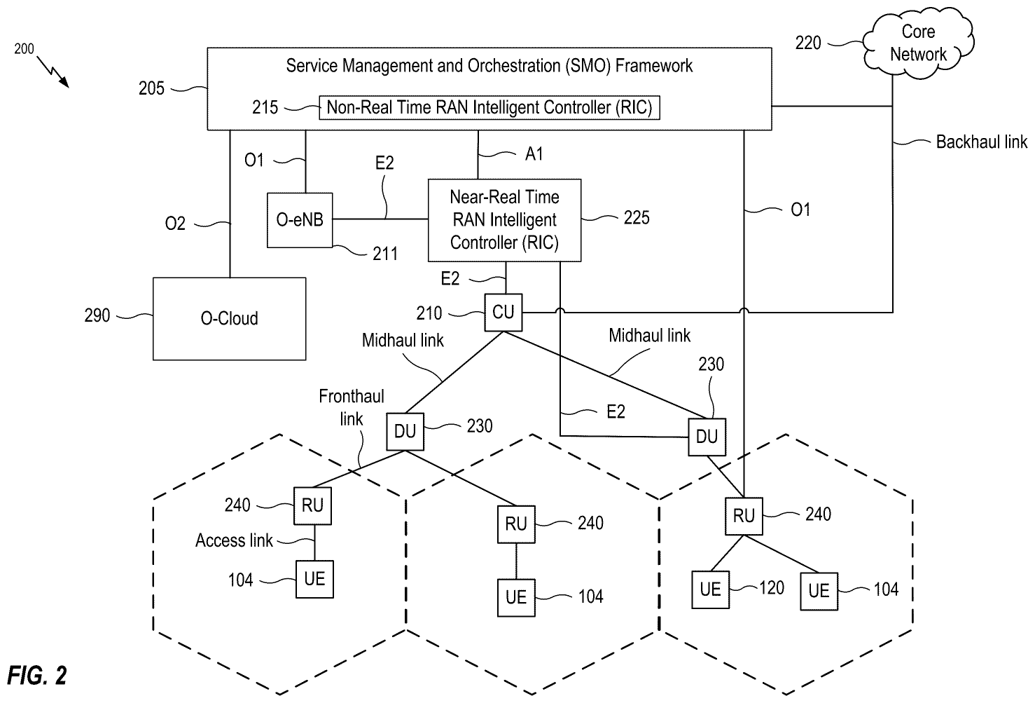

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHz, which is sometimes referred to (interchangeably) as a “millimeter wave” (“mmW” or “mm Wave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104. may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QoS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB. with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

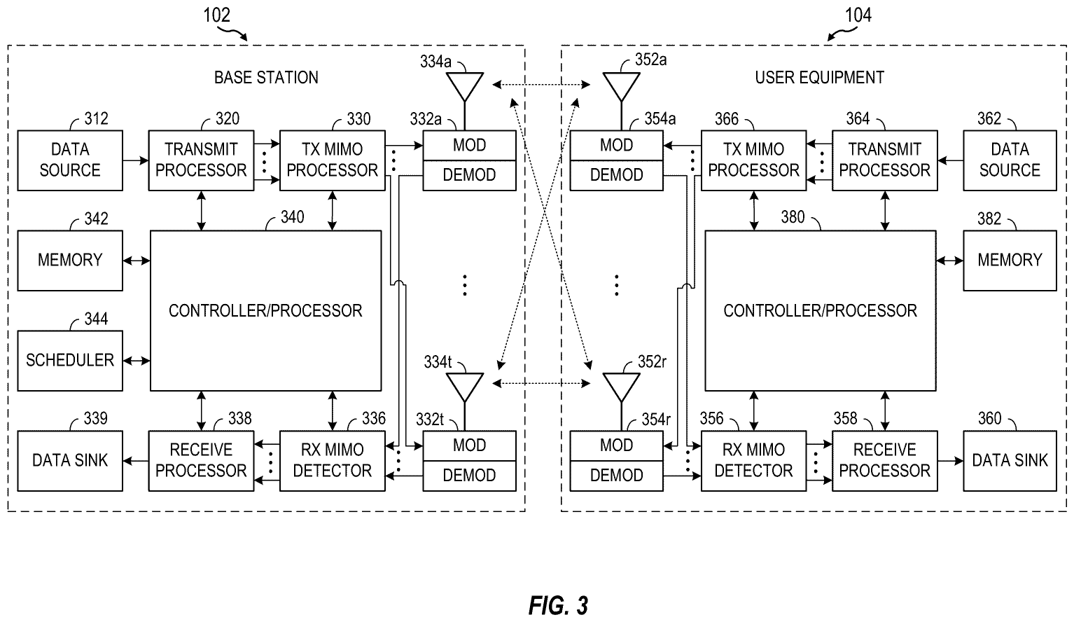

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

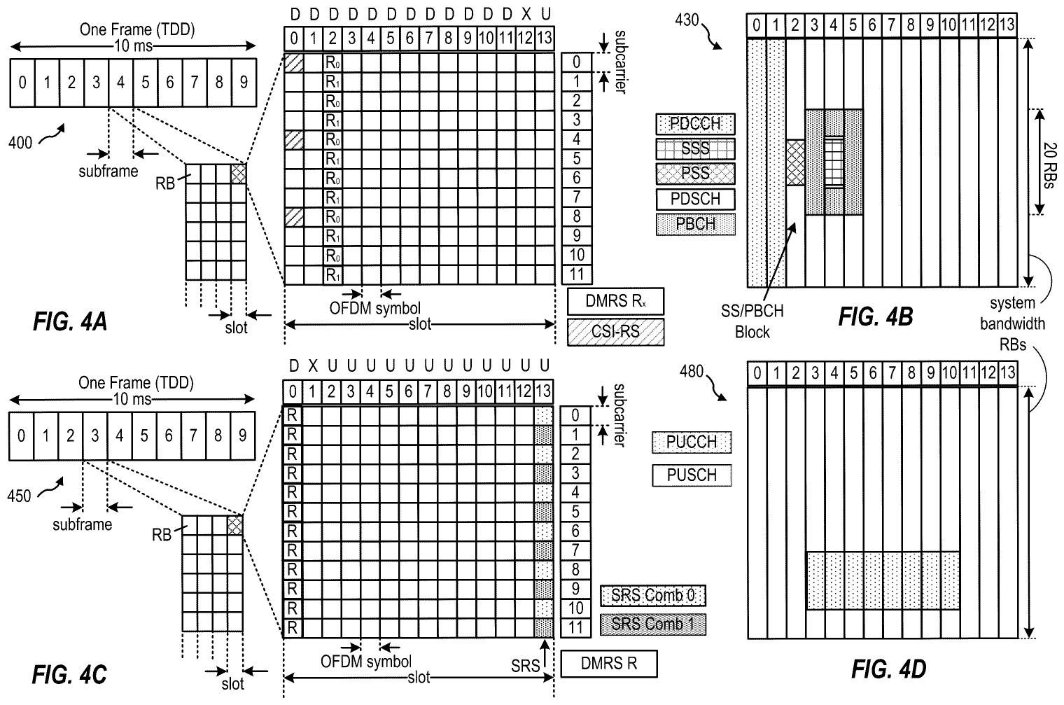

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ×15} kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Reduced Cancelation Indication Monitoring

Aspects of the present disclosure provide apparatuses, methods, processing systems, and computer-readable mediums for selectively monitoring for cancelation indication.

As noted above, uplink cancellation allows a network to prioritize certain types of traffic over other types of traffic. A network may signal a UE to cancel a portion of an already-scheduled lower priority uplink transmission to avoid interference to a higher priority uplink transmission (e.g., from another UE).

For example, when a network entity allocates resources scheduled for enhanced mobile broadband (eMBB) transmissions to an ultra-reliable low latency communication (URLLC) UE (e.g., due to latency requirements), the network entity may transmit an ULCI to the eMBB UEs to ask those UEs to stop their transmissions. When a UE detects the ULCI from the network entity, that UE thus stops the transmission (without resuming the transmission).

In conventional systems, ULCI is typically applicable to physical uplink shared channel (PUSCH) and sounding reference signal (SRS) transmissions. As in the example noted above, ULCI may be implemented with the purpose of improving URLLC UE performance.

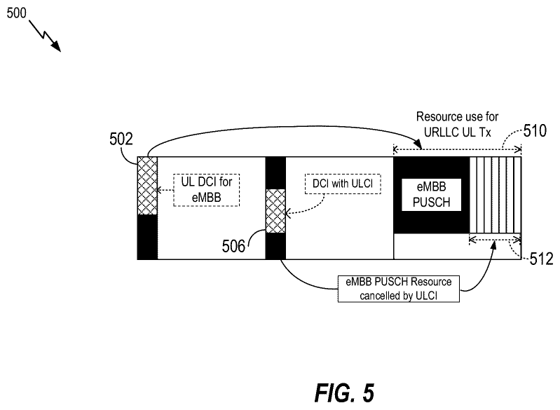

FIG. 5 illustrates a timing diagram 500 for an example scenario where ULCI is used to cancel part of a previously scheduled uplink transmission. As illustrated at 502, the network may schedule (via uplink DCI) a UE with uplink resources for an eMBB PUSCH transmission, that overlap with resources 510 used for URLLC UL transmissions. As illustrated at 506, to accommodate the URLLC traffic, the network may send the UE (DCI with) an ULCI indicating the UE is to cancel a portion 512 of the already scheduled eMBB PUSCH.

Certain systems may have certain types of DCI formats (e.g., NR 5G Release 16 introduces DCI format 2_4) to support UL cancellation for PUSCH or SRS transmissions. In such systems, the network can schedule a group-common DCI Format 2_4 addressed by a cancellation indication radio network temporary identifier (CI-RNTI) to cancel an UL resource previously assigned to eMBB service.

ULCI in DCI format 2_4 may be used to notify UEs to cancel UL Tx on some time and frequency resource sets, within the PUSCH reference time and frequency region. In some systems, ULCI may only be applied to PUSCH (including PUSCH repetition) and SRS.

A UE is typically configured to monitor for ULCI via RRC signaling. For example, if a UE is RRC configured to monitor for ULCI, that UE may be provided a CI-RNTI for monitoring PDCCH candidates for a DCI format 2_4. The uplink cancelation configuration may also provide to the UE with a set of serving cells, by ci-ConfigurationPerServingCell, that includes a set of serving cell indexes and a corresponding set of locations for fields in DCI format 2_4 by positionInDCI. The RRC configuration may indicate monitoring occasions (e.g., search space set resources) for the UE to monitor for ULCI.

As noted above, there are certain situations where a UE may not expect ULCI and monitoring for ULCI in those situations is waste. Unfortunately, if a network entity (e.g., a gNB) wants the UE to stop monitoring for ULCI (e.g., via DCI format 2_4), the network entity typically has to RRC configure or reconfigure the UE to stop monitoring. This type of signaling is relatively slow. As a result, a UE may unnecessarily monitor for ULCI wasting power. Further, by the time RRC reconfiguration is complete, the conditions may have changed and the UE may, again, expect ULCI.

Aspects of the present disclosure, however, provide an alternative way for a UE to adapt ULCI monitoring under certain conditions. In some cases, the conditions may be configured by the network, such that the UE and network will have the same understanding. This may help avoid the scenario where the network sends ULCI when the UE is not monitoring for it. While certain examples refer to a UE autonomously determining how it monitors for ULCI, similar techniques may be applied for monitoring cancelation indications for (already-scheduled) downlink transmissions.

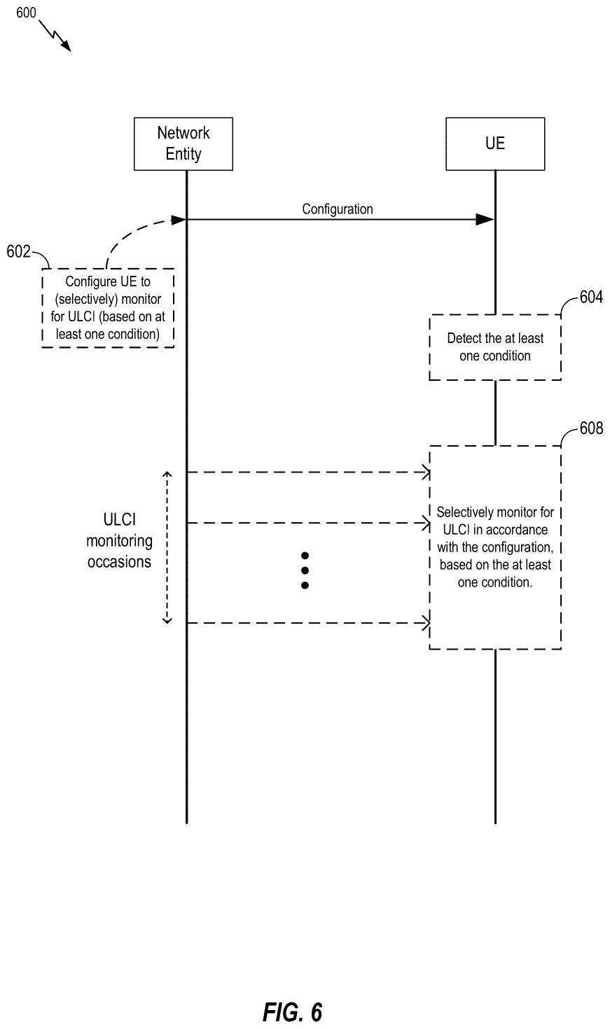

Reduced cancelation indication monitoring proposed herein may be understood with reference to the example call flow diagram 600 of FIG. 6.

In some aspects, the UE shown in FIG. 6 may be an example of the UE 104 depicted and described with respect to FIGS. 1 and 3. In some aspects, the network entity shown in FIG. 6 may be an example of the BS 102 (e.g., a gNB) depicted and described with respect to FIGS. 1 and 3 or a disaggregated base station depicted and described with respect to FIG. 2.

The network may configure the UE to monitor for an indication that indicates cancelation of at least a portion of a scheduled physical uplink shared channel (PUSCH) or at least a portion of a scheduled physical downlink shared channel (PDSCH).

For example, as indicated at 602, the network entity may configure the UE (e.g., via RRC signaling) to selectively monitor for ULCI.

In other words, rather than always monitor for cancelation indications according to the configuration, the UE may selectively monitor for the indication in accordance with the configuration, based on at least one condition. In some cases, the network may indicate the at least one condition.

In the illustrated example, the UE detects the at least one condition, at 604, and selectively monitors for ULCI, at 608. For example, the UE may modify how it monitors for ULCI when the condition is detected (e.g., by skipping ULCI monitoring occasions or reducing how often it monitors ULCI monitoring occasions).

There are various types of conditions that may prompt a UE to modify how it monitors for cancelation indications (such as ULCI). For example, some conditions may be related to extended reality (XR) or URLLC traffic characteristics. Certain traffic for XR applications and URLLC are often of higher priority, due to low latency.

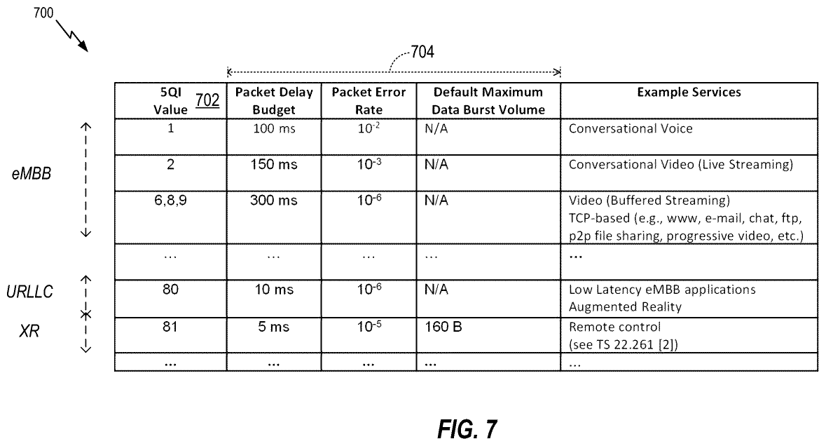

Such traffic characteristics may be indicated through configuration from the network. For example, as shown in table 700 of FIG. 7, different quality of service (QoS) levels index values 702 (5G QoS Identifiers or 5QI) may have different sets of parameters 704. 5QI parameters generally indicate different traffic needs.

As illustrated in table 700, for eMBB, 5QI indices are usually in the first few rows (lower 5QI values) with larger packet delay budgets (PDBs) and higher packet error rates (PERs). For URLLC and XR, 5QI indices are in the lower rows (lower 5QI values), with smaller PDBs and lower PERs. XR traffic characteristics may include high bit rate, high reliability (e.g., PER<=1e−3), and low latency (5 ms<PDB<=25 ms). Such traffic may be for virtual reality (VR)/augmented reality (AR) split rendering and cloud gaming.

As noted above, unnecessarily monitoring for PDCCH with ULCI can increase power consumption. Therefore, in some cases, when high priority UL traffic arrives, the UE may safely assumed that its traffic will not be interrupted. Thus, the UE may not need to monitor for DCI that cancels UL transmission in this case.

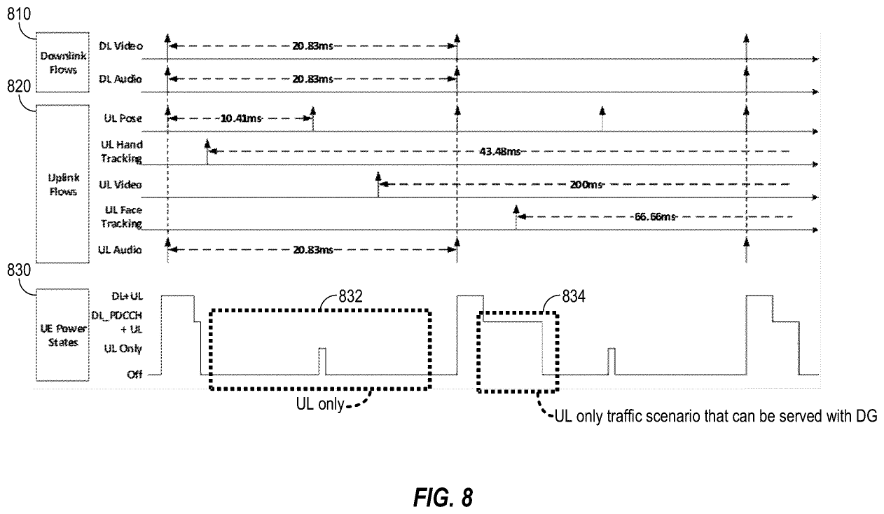

As illustrated in FIG. 8, XR traffic characteristics may result in unbalanced, in terms of the amount of downlink traffic versus uplink traffic at any given time. In the example illustrated in FIG. 8, there are 5 uplink (UL) flows 820 and 2 downlink (DL) flows 810, with packets for each arriving at periodic intervals.

As illustrated at 832 and 834, at certain times, the traffic is only uplink traffic served by a configured grant (CG) or dynamic grant (DG) PUSCH. At other times, there is both UL and DL traffic. While not depicted in the example of FIG. 8, there can also be cases where there is DL traffic only.

As indicated, there are certain power or Network Energy States (NES) 830 where unbalanced traffic, such as downlink only, is expected. In such cases, it make little or no sense for the UE need to monitor for UL CI. For example, if the UE is in a DL only traffic situation for a certain amount of time (e.g., an amount of time or percentage of the time), then the UE may save power by not performing blind decoding to monitor for DCI format 2_4 in ULCI monitoring occasions. As noted above, RRC configuration/reconfiguration is relatively slow and may not be able to adapt UE monitoring configurations to adapt for rapidly changing DL only or UL only traffic or occasional high priority traffic.

Aspects of the present disclosure generally propose configuring a UE to adjust how it monitors for cancellation indications, based on the type of traffic. For example, when the UE is configured for at least one or more high priority traffic, the UE can stop monitoring the UL CI.

In this context, traffic considered high priority may have one or more of the following characteristics: a certain configuration of Packet Error Rate (PER) or a certain configuration of Packet Delay Budget (PDB). Traffic could also be considered high priority if it maps to certain 5QI or rows in 5QI table 700 shown in FIG. 7 or based on an amount of remaining uplink delay budget from a nominal delay budget.

In some cases, Delay Status Reporting (DSR) may be used. DSR may be considered similar to Buffer Status Reporting (BSR), but with DSR a UE may report the experienced delay for different logical channels (rather than the buffer size).

According to certain aspects of the present disclosure, a UE may assume that if it reports one or more delays (associated with different logical channels) that is greater than a threshold, the UE may autonomously stop monitoring for ULCI. In such cases, the threshold may be configured (e.g., via RRC signaling).

In XR scenarios, a UE may be able to obtain some type of information from the UL application layer regarding when the UL traffic ends. Given this information regarding when its traffic might end, the UE may obtain (and send) an end of burst indication or send a zero buffer to gNB. According to certain aspects of the present disclosure, when the UE sends a zero buffer or end of burst indication, the UE may not expect any traffic in the UL for certain time (e.g., X slots or ms). During this time, the UE may autonomously stop monitoring of UL CI.

According to certain aspects, when a UE is in a state that it expects DL traffic only, or unbalanced traffic that mostly consists of DL, the UE may not be expected to monitor the UL CI. As noted above, with reference to FIG. 8, in some cases, being in a DL only state may be indicated through a network energy state (NES).

For example, an NES may correspond to a case when communication, channels, and signals are confined to the DL only transmissions. In such cases, when the UE in a DL only state or unbalanced traffic that mostly consists of DL, the UE may reduce the monitoring to a default periodicity or sparser monitoring occasions.

According to certain aspects, the condition for modifying how to monitor for UL CI (e.g., skipping or reducing how often to monitor ULCI monitoring occasions) may be an indication in a UL CI itself. For example, a DCI conveying UL CI may have an additional one (or more) bit indication that can indicate that the UE is to stop monitoring for a certain time X. For example, the time may cover a DL only state duration or some time where the network entity (e.g., gNB) understands that there are no other UEs with higher priority.

As noted above, the techniques proposed herein may also be applied to modify how the UE monitors for cancelation of downlink transmissions. For example, DL cancelation may be indicated in a mechanism referred to as DL preemption, which may be conveyed in certain DCI formats (e.g., DCI format 2_1). Such a preemption indication (PI) may indicate cancelation of at least a portion of a scheduled PDSCH. A UE may skip or reduce monitoring for PIs, for example, when downlink traffic of a given priority is scheduled or when the UE is in a state associated with a higher percentage of uplink traffic than downlink traffic. For example, if the UE is in an UL only traffic situation for a certain amount of time (e.g., an amount of time or percentage of the time), then the UE may save power by not performing blind decoding to monitor for DCI format 2_1 in PI monitoring occasions.

### Example Operations

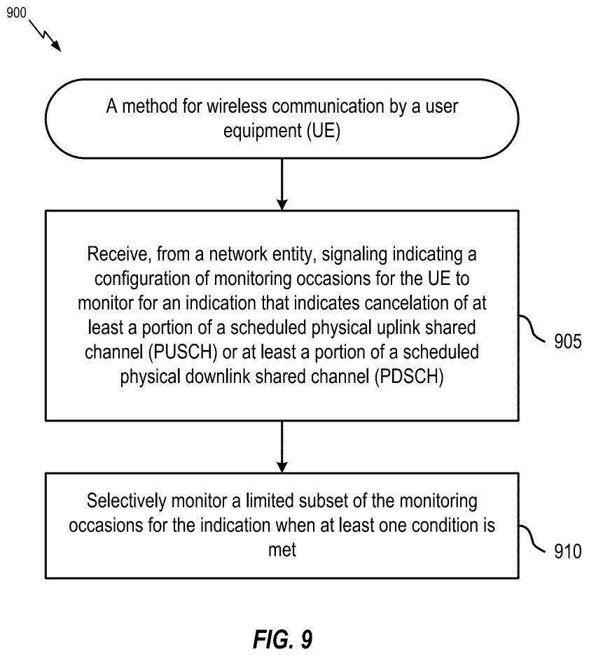

FIG. 9 shows an example of a method 900 of wireless communication by a user equipment (UE), such as a UE 104 of FIGS. 1 and 3.

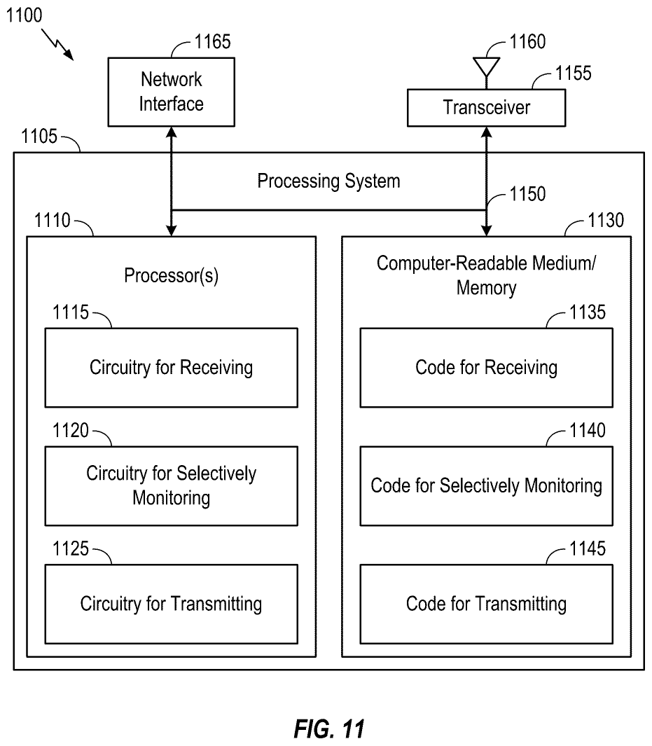

Method 900 begins at step 905 with receiving, from a network entity, signaling indicating a configuration of monitoring occasions for the UE to monitor for an indication that indicates cancelation of at least a portion of a scheduled physical uplink shared channel (PUSCH) or at least a portion of a scheduled physical downlink shared channel (PDSCH). In some cases, the operations of this step refer to, or may be performed by, circuitry for receiving and/or code for receiving as described with reference to FIG. 11.

Method 900 then proceeds to step 910 with selectively monitoring a limited subset of the monitoring occasions for the indication when at least one condition is met. In some cases, the operations of this step refer to, or may be performed by, circuitry for selectively monitoring and/or code for selectively monitoring as described with reference to FIG. 11.

In some aspects, the method 900 further includes receiving, from the network entity, signaling indicating the at least one condition. In some cases, the operations of this step refer to, or may be performed by, circuitry for receiving and/or code for receiving as described with reference to FIG. 11.

In some aspects, selectively monitoring comprises modifying how the UE monitors for the indication when the at least one condition is met.

In some aspects, modifying how the UE monitors for the indication when one or more conditions are met comprises at least one of: skipping or reducing how often the UE monitors for at least one format of downlink control information (DCI) used to convey the indication for a period of time.

In some aspects, the at least one format of DCI comprises a format used to convey a cancelation indication (CI) that indicates cancelation of at least a portion of a scheduled PUSCH.

In some aspects, the at least one condition involves at least one characteristic of uplink traffic; and the at least one condition is met when the UE has uplink traffic of a given priority to send.

In some aspects, the given priority is associated with at least one of: a packet error rate (PER) configuration, a packet delay budget (PDB) configuration, a quality of service (QoS) indicator value, or a remaining uplink delay budget relative to a nominal packet delay budget.

In some aspects, the at least one condition is met when the UE reports at least one delay associated with at least one logical channel that is less than a threshold value.

In some aspects, the at least one condition is met when the UE reports at least one of an end of burst indication or a zero buffer indication.

In some aspects, the at least one condition is met when the UE is in a state associated with a higher percentage of downlink traffic than uplink traffic.

In some aspects, the at least one condition is met when the network indicates, via at least one bit in the at least one format of DCI conveying the indication, that the UE is to skip or reduce how often it monitors for the at least one format of DCI conveying the indication.

In some aspects, the at least one format of DCI comprises a format used to convey a preemption indication (PI) that indicates cancelation of at least a portion of a scheduled PDSCH.

In some aspects, the at least one condition involves at least one characteristic of downlink traffic; and the at least one condition is met when the network entity schedules downlink traffic of a given priority.

In some aspects, the at least one condition is met when the UE is in a state associated with a higher percentage of uplink traffic than downlink traffic.

In one aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative steps are possible consistent with this disclosure.

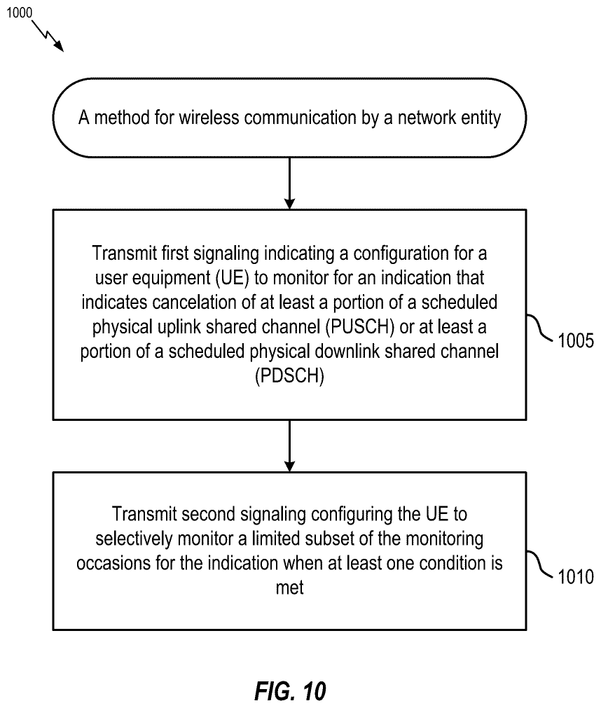

FIG. 10 shows an example of a method 1000 of wireless communication by a network entity, such as a BS 102 of FIGS. 1 and 3, or a disaggregated base station as discussed with respect to FIG. 2.

Method 1000 begins at step 1005 with transmitting first signaling indicating a configuration for a user equipment (UE) to monitor for an indication that indicates cancelation of at least a portion of a scheduled physical uplink shared channel (PUSCH) or at least a portion of a scheduled physical downlink shared channel (PDSCH). In some cases, the operations of this step refer to, or may be performed by, circuitry for transmitting and/or code for transmitting as described with reference to FIG. 11.

Method 1000 then proceeds to step 1010 with transmitting second signaling configuring the UE to selectively monitor a limited subset of the monitoring occasions for the indication when at least one condition is met. In some cases, the operations of this step refer to, or may be performed by, circuitry for transmitting and/or code for transmitting as described with reference to FIG. 11.

In some aspects, the second signaling indicates the at least one condition.

In some aspects, the second signaling configures to the UE to modify how the UE monitors for the indication when the at least one condition is met.

In some aspects, the second signaling configures to the UE to at least one of: skip or reduce how often the UE monitors for at least one format of downlink control information (DCI) used to convey the indication for a period of time.

In some aspects, the at least one format of DCI comprises a format used to convey a cancelation indication (CI) that indicates cancelation of at least a portion of a scheduled PUSCH.

In some aspects, the at least one condition involves at least one characteristic of uplink traffic; and the at least one condition is met when the UE has uplink traffic of a given priority to send.

In some aspects, the given priority is associated with at least one of: a packet error rate (PER) configuration, a packet delay budget (PDB) configuration, a quality of service (QoS) indicator value, or a remaining uplink delay budget relative to a nominal packet delay budget.

In some aspects, the at least one condition is met when the UE reports at least one delay associated with at least one logical channel that is less than a threshold value.

In some aspects, the at least one condition is met when the UE reports at least one of an end of burst indication or a zero buffer indication.

In some aspects, the at least one condition is met when the UE is in a state associated with a higher percentage of downlink traffic than uplink traffic.

In some aspects, the at least one condition is met when the network indicates, via at least one bit in the at least one format of DCI conveying the indication, that the UE is to skip or reduce how often it monitors for the at least one format of DCI conveying the indication.

In some aspects, the at least one format of DCI comprises a format used to convey a preemption indication (PI) that indicates cancelation of at least a portion of a scheduled PDSCH.

In some aspects, the at least one condition involves at least one characteristic of downlink traffic; and the at least one condition is met when the network entity schedules downlink traffic of a given priority.

In some aspects, the at least one condition is met when the UE is in a state associated with a higher percentage of uplink traffic than downlink traffic.

In one aspect, method 1000, or any aspect related to it, may be performed by an apparatus, such as communications device 1100 of FIG. 11, which includes various components operable, configured, or adapted to perform the method 1000. Communications device 1100 is described below in further detail.

Note that FIG. 10 is just one example of a method, and other methods including fewer, additional, or alternative steps are possible consistent with this disclosure.

### Example Communications Device(s)

FIG. 11 depicts aspects of an example communications device 1100. In some aspects, communications device 1100 is a user equipment, such as UE 104 described above with respect to FIGS. 1 and 3. In some aspects, communications device 1100 is a network entity, such as BS 102 of FIGS. 1 and 3, or a disaggregated base station as discussed with respect to FIG. 2.

The communications device 1100 includes a processing system 1105 coupled to the transceiver 1155 (e.g., a transmitter and/or a receiver). In some aspects (e.g., when communications device 1100 is a network entity), processing system 1105 may be coupled to a network interface 1165 that is configured to obtain and send signals for the communications device 1100 via communication link(s), such as a backhaul link, midhaul link, and/or fronthaul link as described herein, such as with respect to FIG. 2. The transceiver 1155 is configured to transmit and receive signals for the communications device 1100 via the antenna 1160, such as the various signals as described herein. The processing system 1105 may be configured to perform processing functions for the communications device 1100, including processing signals received and/or to be transmitted by the communications device 1100.

The processing system 1105 includes one or more processors 1110. In various aspects, the one or more processors 1110 may be representative of one or more of receive processor 358, transmit processor 364, TX MIMO processor 366, and/or controller/processor 380, as described with respect to FIG. 3. In various aspects, one or more processors 1110 may be representative of one or more of receive processor 338, transmit processor 320, TX MIMO processor 330, and/or controller/processor 340, as described with respect to FIG. 3. The one or more processors 1110 are coupled to a computer-readable medium/memory 1130 via a bus 1150. In certain aspects, the computer-readable medium/memory 1130 is configured to store instructions (e.g., computer-executable code) that when executed by the one or more processors 1110, cause the one or more processors 1110 to perform the method 900 described with respect to FIG. 9, or any aspect related to it; and the method 1000 described with respect to FIG. 10, or any aspect related to it. Note that reference to a processor performing a function of communications device 1100 may include one or more processors 1110 performing that function of communications device 1100.

In the depicted example, computer-readable medium/memory 1130 stores code (e.g., executable instructions), such as code for receiving 1135, code for selectively monitoring 1140, and code for transmitting 1145. Processing of the code for receiving 1135, code for selectively monitoring 1140, and code for transmitting 1145 may cause the communications device 1100 to perform the method 900 described with respect to FIG. 9, or any aspect related to it; and the method 1000 described with respect to FIG. 10. or any aspect related to it.

The one or more processors 1110 include circuitry configured to implement (e.g., execute) the code stored in the computer-readable medium/memory 1130, including circuitry for receiving 1115, circuitry for selectively monitoring 1120, and circuitry for transmitting 1125. Processing with circuitry for receiving 1115, circuitry for selectively monitoring 1120, and circuitry for transmitting 1125 may cause the communications device 1100 to perform the method 900 described with respect to FIG. 9, or any aspect related to it; and the method 1000 described with respect to FIG. 10, or any aspect related to it.

Various components of the communications device 1100 may provide means for performing the method 900 described with respect to FIG. 9, or any aspect related to it; and the method 1000 described with respect to FIG. 10, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 1155 and the antenna 1160 of the communications device 1100 in FIG. 11. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 1155 and the antenna 1160 of the communications device 1100 in FIG. 11.

### Example Clauses

Implementation examples are described in the following numbered clauses:

Clause 1: A method for wireless communication by a user equipment (UE), comprising: receiving, from a network entity, signaling indicating a configuration of monitoring occasions for the UE to monitor for an indication that indicates cancelation of at least a portion of a scheduled physical uplink shared channel (PUSCH) or at least a portion of a scheduled physical downlink shared channel (PDSCH); and selectively monitoring a limited subset of the monitoring occasions for the indication when at least one condition is met.

Clause 2: The method of Clause 1, further comprising receiving, from the network entity, signaling indicating the at least one condition.

Clause 3: The method of any one of Clauses 1-2, wherein the indication is conveyed in at least one format of downlink control information (DCI).

Clause 4: The method of Clause 3, wherein selectively monitoring comprises at least one of: skipping or reducing how often the UE monitors for the at least one format of DCI in the monitoring occasions for a period of time.

Clause 5: The method of Clause 4, wherein the at least one format of DCI comprises a format used to convey a cancelation indication (CI) that indicates cancelation of at least a portion of a scheduled PUSCH.

Clause 6: The method of Clause 5, wherein: the at least one condition is met when the UE has uplink traffic of a given priority to send.

Clause 7: The method of Clause 6, wherein the given priority is associated with at least one of: a packet error rate (PER) configuration, a packet delay budget (PDB) configuration, a quality of service (QoS) indicator value, or a remaining uplink delay budget relative to a nominal packet delay budget.

Clause 8: The method of Clause 5, wherein: wherein the at least one condition is met when at least one delay associated with at least one logical channel is greater than a threshold value.

Clause 9: The method of Clause 5, wherein: the at least one condition is met when the UE obtains or reports at least one of an end of burst indication or a zero buffer indication.

Clause 10: The method of Clause 5, wherein: the at least one condition is met when the UE is in a state associated with a higher percentage of downlink traffic than uplink traffic.

Clause 11: The method of Clause 4, wherein: the at least one condition is met when the network entity indicates, via at least one bit in the at least one format of DCI, that the UE is to skip or reduce how often it monitors for the at least one format of DCI in the monitoring occasions.

Clause 12: The method of Clause 4, wherein the at least one format of DCI comprises a format used to convey a preemption indication (PI) that indicates cancelation of at least a portion of a scheduled PDSCH.

Clause 13: The method of Clause 12, wherein: the at least one condition is met when the network entity schedules downlink traffic of a given priority.

Clause 14: The method of Clause 12, wherein: the at least one condition is met when the UE is in a state associated with a higher percentage of uplink traffic than downlink traffic.

Clause 15: A method for wireless communication by a network entity, comprising: transmitting first signaling indicating a configuration for a user equipment (UE) to monitor for an indication that indicates cancelation of at least a portion of a scheduled physical uplink shared channel (PUSCH) or at least a portion of a scheduled physical downlink shared channel (PDSCH); and transmitting second signaling configuring the UE to selectively monitor a limited subset of the monitoring occasions for the indication when at least one condition is met.

Clause 16: The method of Clause 15, wherein the second signaling indicates the at least one condition.

Clause 17: The method of any one of Clauses 15-16, wherein the indication is conveyed in at least one format of downlink control information (DCI).

Clause 18: The method of Clause 17, wherein the second signaling configures to the UE to at least one of: skip or reduce how often the UE monitors for the at least one format of DCI in the monitoring occasions for a period of time.

Clause 19: The method of Clause 18, wherein the at least one format of DCI comprises a format used to convey a cancelation indication (CI) that indicates cancelation of at least a portion of a scheduled PUSCH.

Clause 20: The method of Clause 19, wherein: the at least one condition is met when the UE has uplink traffic of a given priority to send.

Clause 21: The method of Clause 20, wherein the given priority is associated with at least one of: a packet error rate (PER) configuration, a packet delay budget (PDB) configuration, a quality of service (QoS) indicator value, or a remaining uplink delay budget relative to a nominal packet delay budget.

Clause 22: The method of Clause 19, wherein: the at least one condition is met when at least one delay associated with at least one logical channel is greater than a threshold value.

Clause 23: The method of Clause 19, wherein: the at least one condition is met when the UE obtains or reports at least one of an end of burst indication or a zero buffer indication.

Clause 24: The method of Clause 19, wherein: the at least one condition is met when the UE is in a state associated with a higher percentage of downlink traffic than uplink traffic.

Clause 25: The method of Clause 18, wherein: the at least one condition is met when the network entity indicates, via at least one bit in the at least one format of DCI, that the UE is to skip or reduce how often it monitors for the at least one format of DCI in the monitoring occasions.

Clause 26: The method of Clause 18, wherein the at least one format of DCI comprises a format used to convey a preemption indication (PI) that indicates cancelation of at least a portion of a scheduled PDSCH.

Clause 27: The method of Clause 26, wherein: the at least one condition is met when the network entity schedules downlink traffic of a given priority.

Clause 28: The method of Clause 26, wherein: the at least one condition is met when the UE is in a state associated with a higher percentage of uplink traffic than downlink traffic.

Clause 29: An apparatus, comprising: a memory comprising executable instructions; and a processor configured to execute the executable instructions and cause the apparatus to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by a processor of an apparatus, cause the apparatus to perform a method in accordance with any one of Clauses 1-28.

Clause 32: A computer program product embodied on a computer-readable storage medium comprising code for performing a method in accordance with any one of Clauses 1-28.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communications by a user equipment (UE), comprising a memory comprising executable instructions, and one or more processors configured to execute the executable instructions and cause the UE to:
receive, from a network entity, signaling indicating a configuration of monitoring occasions for the UE to monitor for an indication that indicates cancelation of at least a portion of a scheduled physical uplink shared channel (PUSCH) or at least a portion of a scheduled physical downlink shared channel (PDSCH); and
selectively monitor a limited subset of the monitoring occasions for the indication when at least one condition is met.

2. The apparatus of claim 1, wherein the one or more processors are further configured to execute the executable instructions and cause the UE to:
receive, from the network entity, signaling indicating the at least one condition.

3. The apparatus of claim 1, wherein the indication is conveyed in at least one format of downlink control information (DCI).

4. The apparatus of claim 3, wherein:
selectively monitoring comprises at least one of: skipping or reducing how often the UE monitors for the at least one format of DCI in the monitoring occasions for a period of time.

5. The apparatus of claim 4, wherein the at least one format of DCI comprises a format used to convey a cancelation indication (CI) that indicates cancelation of at least a portion of a scheduled PUSCH.

6. The apparatus of claim 5, wherein the at least one condition is met when the UE has uplink traffic of a given priority to send.

7. The apparatus of claim 6, wherein the given priority is associated with at least one of: a packet error rate (PER) configuration, a packet delay budget (PDB) configuration, a quality of service (QoS) indicator value, or a remaining uplink delay budget relative to a nominal packet delay budget.

8. The apparatus of claim 5, wherein the at least one condition is met when at least one delay associated with at least one logical channel is greater than a threshold value.

9. The apparatus of claim 5, wherein the at least one condition is met when the UE obtains or reports at least one of an end of burst indication or a zero buffer indication.

10. The apparatus of claim 5, wherein the at least one condition is met when the UE is in a state associated with a higher percentage of downlink traffic than uplink traffic.

11. The apparatus of claim 4, wherein the at least one condition is met when the network entity indicates, via at least one bit in the at least one format of DCI, that the UE is to skip or reduce how often it monitors for the at least one format of DCI in the monitoring occasions.

12. The apparatus of claim 4, wherein the at least one format of DCI comprises a format used to convey a preemption indication (PI) that indicates cancelation of at least a portion of a scheduled PDSCH.

13. The apparatus of claim 12, wherein the at least one condition is met when the network entity schedules downlink traffic of a given priority.

14. The apparatus of claim 12, wherein the at least one condition is met when the UE is in a state associated with a higher percentage of uplink traffic than downlink traffic.

15. An apparatus for wireless communications by a network entity, comprising a memory comprising executable instructions, and one or more processors configured to execute the executable instructions and cause the network entity to:
transmit first signaling indicating a configuration of monitoring occasions for a user equipment (UE) to monitor for an indication that indicates cancelation of at least a portion of a scheduled physical uplink shared channel (PUSCH) or at least a portion of a scheduled physical downlink shared channel (PDSCH); and
transmit second signaling configuring the UE to selectively monitor a limited subset of the monitoring occasions for the indication when at least one condition is met.

16. The apparatus of claim 15, wherein the second signaling indicates the at least one condition.

17. The apparatus of claim 15, wherein the indication is conveyed in at least one format of downlink control information (DCI).

18. The apparatus of claim 17, wherein the second signaling configures to the UE to at least one of: skip or reduce how often the UE monitors for the at least one format of DCI in the monitoring occasions for a period of time.

19. The apparatus of claim 18, wherein the at least one format of DCI comprises a format used to convey a cancelation indication (CI) that indicates cancelation of at least a portion of a scheduled PUSCH.

20. The apparatus of claim 19, wherein the at least one condition is met when the UE has uplink traffic of a given priority to send.

21. The apparatus of claim 20, wherein the given priority is associated with at least one of: a packet error rate (PER) configuration, a packet delay budget (PDB) configuration, a quality of service (QoS) indicator value, or a remaining uplink delay budget relative to a nominal packet delay budget.

22. The apparatus of claim 19, wherein the at least one condition is met when at least one delay associated with at least one logical channel is greater than a threshold value.

23. The apparatus of claim 19, wherein the at least one condition is met when the UE obtains or reports at least one of an end of burst indication or a zero buffer indication.

24. The apparatus of claim 19, wherein the at least one condition is met when the UE is in a state associated with a higher percentage of downlink traffic than uplink traffic.

25. The apparatus of claim 18, wherein: the at least one condition is met when the network entity indicates, via at least one bit in the at least one format of DCI, that the UE is to skip or reduce how often it monitors for the at least one format of DCI in the monitoring occasions.

26. The apparatus of claim 18, wherein the at least one format of DCI comprises a format used to convey a preemption indication (PI) that indicates cancelation of at least a portion of a scheduled PDSCH.

27. The apparatus of claim 26, wherein the at least one condition is met when the network entity schedules downlink traffic of a given priority.

28. The apparatus of claim 26, wherein: the at least one condition is met when the UE is in a state associated with a higher percentage of uplink traffic than downlink traffic.

29. A method for wireless communication by a user equipment (UE), comprising:
receiving, from a network entity, signaling indicating a configuration of monitoring occasions for the UE to monitor for an indication that indicates cancelation of at least a portion of a scheduled physical uplink shared channel (PUSCH) or at least a portion of a scheduled physical downlink shared channel (PDSCH); and
selectively monitoring a limited subset of the monitoring occasions for the indication when at least one condition is met.

30. A method for wireless communication by a network entity, comprising:
transmitting first signaling indicating a configuration of monitoring occasions for a user equipment (UE) to monitor for an indication that indicates cancelation of at least a portion of a scheduled physical uplink shared channel (PUSCH) or at least a portion of a scheduled physical downlink shared channel (PDSCH); and
transmitting second signaling configuring the UE to selectively monitor a limited subset of the monitoring occasions for the indication when at least one condition is met.
